(19) United States
(12) Patent Application Publication
(10) Pub. No.: US 2010/0318201 A1
(43) Pub. Date: Dec. 16, 2010

(54) METHOD AND SYSTEM FOR DETECTING EFFECT OF LIGHTING DEVICE

(75) Inventors: Roel P.G. Cuppen, Eindhoven (NL); Winfried A.H. Berkvens, Eindhoven (NL); Mark H. Verberkt, Eindhoven (NL)

Correspondence Address: BURNS & LEVINSON, LLP, 125 SUMMER STREET, BOSTON, MA, 02110, US

(73) Assignee: AMBX UK LIMITED, Redhill, Surrey (GB)

(21) Appl. No.: 12/445,958

(22) PCT Filed: Oct. 12, 2007
(86) PCT No.: PCT/IB2007/054156

§ 371 Date: Jun. 9, 2009

(30) Foreign Application Priority Data
Oct. 18, 2006 (EP) 06122487.9

(51) Int. Cl. H05B 37/00; G06F 17/00

(52) U.S. Cl. 700/90; 315/363

(57) ABSTRACT

A method comprises transmitting an operate signal from a control system to an effects device, operating the effects device according to the operate signal, detecting an effect of the effects device, assigning a location to said effect, and storing the location of said effect. The effects device can comprise a lighting device, and the method can be repeated for multiple effects devices.

### FIELD OF THE INVENTION

This invention relates to a method of and system for detecting and locating the effect of an effects device, such as a lighting device. The invention provides the automatic location calibration for multiple effects devices, such as lighting devices, present in an ambient environment system.

### BACKGROUND OF THE INVENTION

Developments in the entertainment world have led to the creation of augmentation systems, which provide additional effects in addition to a user's primary entertainment experience. An example of this would be a film, which is being presented by a display device and connected audio devices, and is augmented by other devices in the ambient environment. These additional devices may be, for example, lighting devices, or temperature devices etc. that are controlled in line with the film's content. If a scene is being shown in the film that is underwater, then additional lights may provide a blue ambient environment, and a fan may operate to lower the temperature of the room.

The project amBX (see www.amBX.com) is developing a scripting technology that enables the description of effects that can enhance a content experience. In essence, amBX is a form of markup language for describing the high-level descriptions of enhanced experiences. From the scripts, an amBX engine generates information containing low-level input for devices at different locations in the user's environment. The amBX engine communicates this input to the effects devices, which steer their actuators with this input. Together, the output of various actuators of the augmenting devices at the specific locations creates the enhanced experiences described by the amBX scripts for those locations.

An example of an effects device is a lighting device. Such a lighting device is able to provide coloured light based on incoming messages, according to the protocol of the augmenting system. These messages are sent by the amBX engine based on among others the location (as specified during system configuration). This lighting device only processes those light commands that are a result of running amBX scripts that generate coloured light effects for the location of the lighting device.

Currently, the user has to manually set the location of the effects devices, for example, by using a selector mechanism or by entering a location in a user interface offering a suitable entry point. This can be difficult for a user, in the sense that the user has to know and understand the concept of the location model that is being used by the specific augmentation system that is providing the extra effects. A typical non-expert user does not know and probably does not want to know these concepts.

In the amBX environment, amBX devices inform the amBX engine at which location they generate their effect by sending a device fragment to the amBX engine. This device fragment consists of the capability of the amBX device and its location in the amBX world. For this, an amBX location model has been defined which is currently based on the wind directions on a compass (North, South, East, and West). However, this location model could be extended with other locations in the future. An example of such a device fragment 10 is shown in FIG. 1. In this example (see FIG. 1) the amBX device resides at location “N”, which stands for “North” using the current amBX location model.

Currently, it is only possible to manually set the location of an effects device by, for instance, adjusting a location switch on the lighting device itself or changing the location setting in the device fragment. This results in a change of the value of the <location> tag in its device fragment.

United States Patent Application Publication US 2005/0275626 discloses methods and systems for providing audio/visual control systems that also control lighting systems, including for advanced control of lighting effects in real time by video jockeys and similar professionals. An embodiment in this document is a method of automatically capturing the position of the light systems within an environment. A series of steps may be used to accomplish this method. First, the environment to be mapped may be darkened by reducing ambient light. Next, control signals can be sent to each light system, commanding the light system to turn on and off in turn. Simultaneously, the camera can capture an image during each “on” time. Next, the image is analyzed to locate the position of the “on” light system. At a next step, a centroid can be extracted, and the centroid position of the light system is stored and the system generates a table of light systems and centroid positions. This data can be used to populate a configuration file. In sum, each light system, in turn, is activated, and the centroid measurement determined. This is done for all of the light systems. An image thus gives a position of the light system in a plane, such as with (x, y) coordinates.

The methods and systems in this document include methods and systems for providing a mapping facility of a light system manager for mapping locations of a plurality of light systems. In embodiments, the mapping system discovers lighting systems in an environment, using techniques described above. In embodiments, the mapping facility then maps light systems in a two-dimensional space, such as using a graphical user interface.

The systems described in this document all deliver information relating to the location of a light system in an environment containing multiple light systems. In many situations, this information is not useful in an augmenting system, because the location of a light, or indeed the location of any effects device, is not sufficient to deliver a useful system, with respect to the user's actual experience of the system.

### SUMMARY OF THE INVENTION

It is therefore an object of the invention to improve upon the known art.

According to a first aspect of the present invention, there is provided a method comprising transmitting an operate signal from a control system to an effects device, operating the effects device according to the operate signal, detecting an effect of the effects device, assigning a location to said effect, and storing the location of said effect.

According to a second aspect of the present invention, there is provided a system comprising a control system, a detecting device and one or more effects devices, the control system arranged to transmit an operate signal to an effects device, the effects device arranged to operate according to the operate signal, the detecting device arranged to detect an effect of the effects device, and the control system further arranged to assign a location to said effect, and to store the location of said effect,

According to a third aspect of the present invention, there is provided a computer program product on a computer readable medium, the product for operating a system and comprising instructions for transmitting an operate signal from a control system to an effects device, operating the effects device according to the operate signal, detecting an effect of the effects device, assigning a location to said effect, and storing the location of said effect.

Owing to the invention, it is possible to ascertain and store the location of the effect produced by a device, which in many cases will be very different from the actual physical location of that device. In respect of a lighting device, for example, the light may be positioned on one side of a room, but the actual illumination provided by that light will be at another side of the room. The obtaining of the location information about the effect of a device rather than the device itself has the principal advantage that effects to be delivered in specific locations can be targeted to the correct device or devices, regardless of the actual locations of those devices, which may be well away from where the effect is being delivered.

Other types of effects devices, such as fans provide effects that are directional, and the actual location of the effect of the device will depend on factors such as the topology of the furniture and so on with in the room. It is also the case that the location of the effect of a device will change, without the actual location of the device itself changing. This could occur as a result of other changes within the environment. The present invention is able to keep track of the dynamic location of the effects produced by each and all effects devices providing augmentation. Other effects devices such as audio devices and smoke devices can also have their effect located with the method and system.

The invention proposes automatically to obtain the location for the effect generated by devices such as amBX devices. This can be done by using one or more control devices that have directional sensitivity (based on sensor measurements). The current invention targets especially lighting devices, for which light intensity can be measured and the result of the measurement can be mapped on a location grid, which results in the determination of the location of the effect produced by the effect device.

One advantage of this invention is that assigning amBX locations to, for example, an amBX lighting effect device is done automatically and is therefore less complicated for non-expert users. The invention is suitable for use in an amBX environment with an amBX system and amBX lighting devices. it is likely that the lighting devices will be the most common device in future augmentation environments. This invention offers the possibility to assign locations to these lighting devices in an automatic and non-complicated way for users.

Advantageously, the step of storing the location of said effect, stores the location on a storage device in the respective effects device or on a storage device in the control system. If the location of the effect is stored at a location away from the actual effects device, then the method further comprises storing identification data identifying said effects device.

Preferably, the method further comprises repeating the method for multiple effects devices. In most systems, numerous effects devices will be present and the method system provide for the repetition of the discovery process that ascertains the location of the effect of each device in the augmentation system.

This repeating process may involve the use of multiple detecting devices to actually correctly work out the location of the effect of each device. If different types of effects devices are present in the system, then it is likely that respective different detecting devices are needed to work out the effect location for each different type of device. So a camera or suitable imaging device can be used for each lighting effect device, and a windsock or similar device can be used if the effect device is a fan.

Ideally the operate signal transmitted to the effects device comprises an on signal, and the method further comprises transmitting a further operate signal to the effects device, this further operate signal transmitted to the effects device comprising an off signal. In this way the effect device is turned on and off for the purposes of identifying the location of the effect produced by the device. This is especially appropriate if the system is cycling through the different devices in turn.

The operate signal need not be of the on/off variety, as it may be advisable in some situations to use a change in gradient of the actual operating intensity of a device, and it can be the case that different effect locations can be categorised for the same device, dependent on the actual operating configuration of that device.

For example, a device may have three possible function positions, off, low and high. This could be the case for any type of effects device. The method may therefore obtain location information of the effect generated for both the “low” and “high” configurations of that device. The method can further comprise transmitting a series of different operate signals from the control system to the effects device, operating the effects device according to the different operate signals, and in this way, calculating an intensity curve for the effects device.

Preferably, the method can further comprise measuring a delay between transmitting the operate signal from the control system to the effects device, and the detecting of the effect of the effects device. The system can be used to measure a delay between an instruction being sent to a device and that device actually carrying out the instruction. This can be used to calibrate time delays in the effects devices and can therefore be used to adapt the transmitting of instructions to effects device to ensure correct synchronisation when the augmentation system is running Delay can also be calculated by measuring the delay between the detected effects of two devices which are sent operate signals at the same time.

Advantageously, the method can further comprise detecting an effect of a test device and measuring a difference between the effect of the effects device and the effect of the test device. The test device may be another effects device, or may be a device such as a television which does not form part of the set of devices used in the augmentation system. This can be used to detect colour differences for example between a lighting device and a television, again for the purpose of calibrating the actual performance of the effects device.

The method can also comprise simultaneously transmitting an operate signal from the control system to a second effects device, operating the second effects device according to the operate signal, detecting a combined effect of the two effects device, assigning a location to said combined effect, and storing the location of said combined effect.

The detecting device can advantageously comprise a reference point located on the detecting device, for positioning of the detecting device. This reference point could be visible on the sensor device itself. For example, an arrow could be provided which the user has to point to a television, thereby positioning the detecting device.

### BRIEF DESCRIPTION OF THE DRAWINGS

Embodiments of the present invention will now be described, by way of example only, with reference to the accompanying drawings, in which:—

FIG. 1 is a diagram of an XML device fragment for use in an augmentation system,

FIG. 2 is a schematic diagram of a system for determining the location of an effect produced by an effects device such as a lamp,

FIG. 3 is a flow diagram of a method of operating the system of FIG. 2,

FIG. 4 is a schematic diagram of a pair of effects devices operating in the system of FIG. 2,

FIG. 5 is a schematic diagram, similar to FIG. 4 of the pair of effects devices, with one device operating according to an operation signal,

FIG. 6 is a schematic diagram of a location grid, and

FIG. 7 is a schematic diagram, of the pair of effects devices, as seen in FIG. 5, with the location grid of FIG. 6 superimposed.

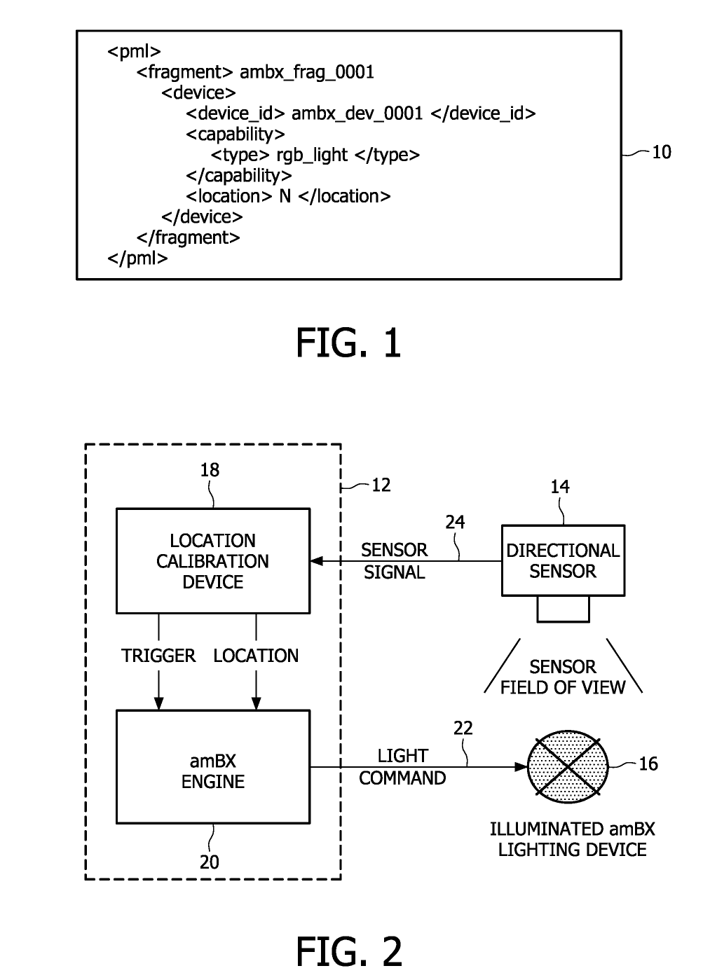

### DETAILED DESCRIPTION OF EMBODIMENTS

FIG. 2 shows a system which comprises a control system 12, a detecting device 14 and one or more effects devices 16. The effects device 16 is a lighting device 16. The control system 12 has two components, a location calibration unit 18 and an amBX engine 20. The configuration of the control system 12 can be a dedicated piece of hardware, or could be a distributed software application that is responsible for the control of the various effects devices 16.

One possible embodiment is for the detecting device 14 to comprise a small location calibration device with a sensor that is directionally sensitive, such as a (wide-angle) camera or directional light sensor. This sensor can be placed at the location where the user normally resides when he or she is using the overall augmentation system.

The control system 12 is arranged to transmit an operate signal 22 to the effects device 16. By means of a trigger from the location calibration device 18, which can be a software application, the lighting device 16 in the amBX environment is turned on. This effect of this illuminated lighting device 16 can be detected by the directional sensor 14 in its field of view when the environment in which the lighting device resides is dark. The effects device 16 is arranged to operate according to the operate signal 22, and the detecting device 14 is arranged to detect an effect of the effects device 16.

The control system 12 is further arranged to assign a location to the detected effect, and to store the location of said effect. When the effect of the illuminated lighting device 16 is detected in the sensor field of view, the location calibration unit 18 can determine at which location the lighting device 16 generates its light effect by analysing the sensor signal 24 and by mapping a location model to the sensor signal 24.

Subsequently, the location calibration unit 18 sends this location to the amBX engine 20. This amBX engine 20 has several options to store the location of the lighting device 16. The amBX engine 20 can store the location setting of the lighting device locally in the amBX engine 20, or the amBX engine 20 can store the location setting in the lighting device 16 itself. A storage device located either on the effects device 16 stores the location, or a storage device connected to the amBX engine 20 stores the location, along with some identification data identifying the specific effects device 16.

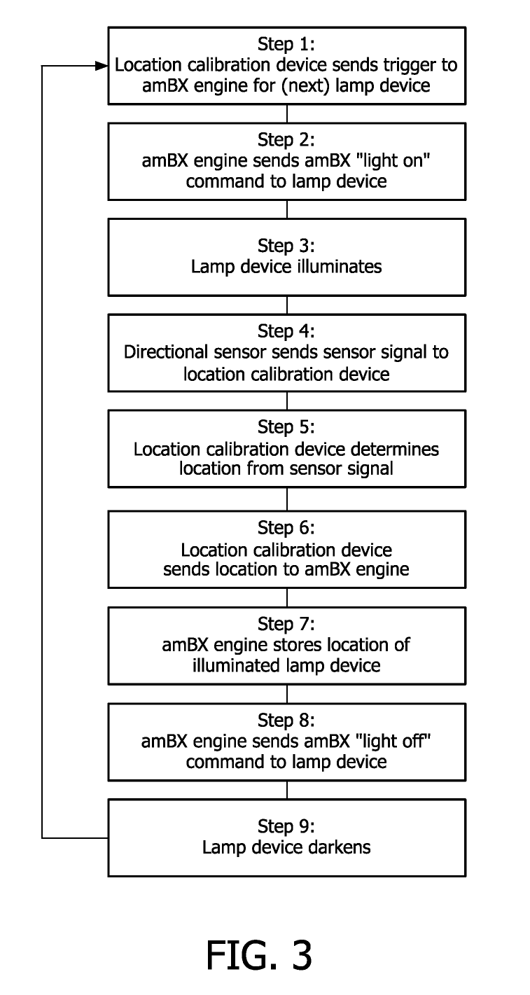

The location calibration process, which is described above is repeated for all lighting devices 16 that have announced themselves to the amBX engine 20. FIG. 3 summarises the methodology of the acquiring process, which obtains the location of the individual effects devices in turn.

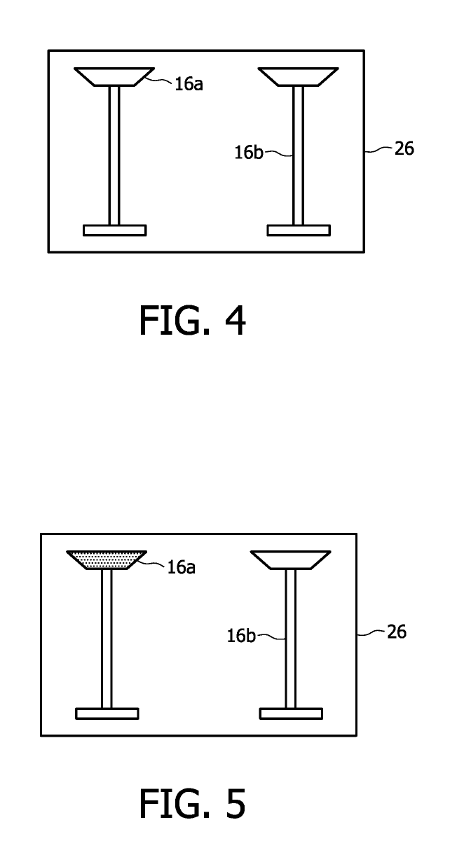

A more detailed example of the operation of the control system is shown with respect to FIGS. 4 to 7. An example of a directional sensor 14 is a camera, such as a simple webcam, that is placed at the likely location of the user in an environment. This camera is faced by a dark scene in which one or more amBX lighting devices 16 reside, see FIG. 4. This Fig. shows an environment 26 which would contain an augmentation system. FIG. 4 is a very simplified view of such a system. For more detail United States Patent Application Publication US2002/0169817 is referred to.

In the implementation of FIGS. 4 to 7, a specific lighting device 16a is illuminated after a trigger of the location calibration device 18 with the control system 12. An image of the scene is made after the lighting device 16a is illuminated, as shown in FIG. 5. The location calibration device 18 analyses this image by putting a location model in the form of a location grid on top of the image.

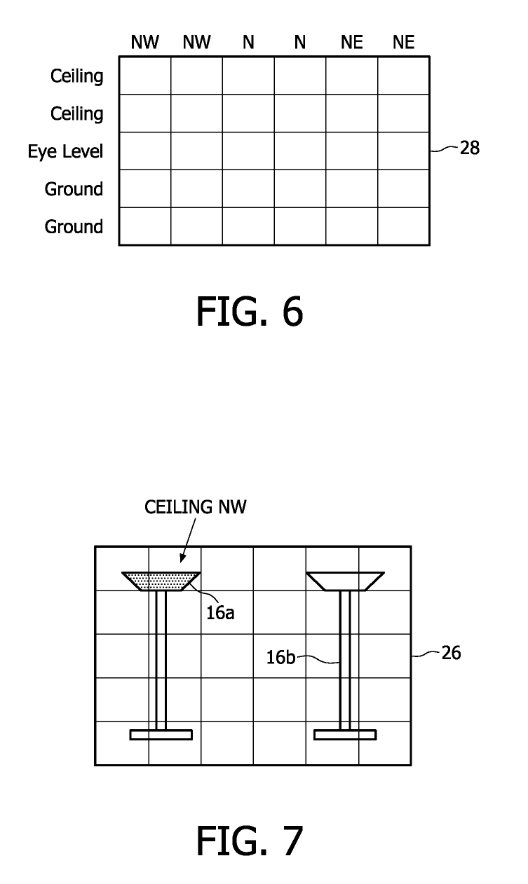

An example of such a location grid 28 is shown in FIG. 6. This location grid 28 can also contain the height of the location. Of course, location grids can have different formats and can have different block sizes. For example, in case of a camera with a wide-angle lens, the lines in the location grid are not straight and not orthogonal. This location grid 28 is used to assign a location to the effect that is detected by the detecting device 14. The location grid could be 3-dimensional.

FIG. 7 shows how the location grid 28 is superimposed on the image received by the detecting device 14. In one embodiment, an algorithm is applied to the luminance values of the grid blocks, which determines the location of the effect from the illuminated lighting device 16a. An example of such an algorithm is selecting the block with the highest luminance (sum of luminance of the block pixels) or the highest average luminance (average of luminance of the block pixels). The latter is required if the block sizes are not equal (in number of pixels).

In the example of FIGS. 4 to 7, the location of the effect generated by the left lighting device 16a is “NW”, because the location assigned to the block with the highest luminance is the “NW” block. The height of this block and therefore also the height of the effect generated by the left lighting device 16a is “Ceiling”.

Another algorithm could be to check, for example, every set of 9 blocks in the format 3 by 3 on the total grid and if this block results in the highest luminance sum of the block or highest average luminance than the centre block determines the position of the lighting device in the location grid.

The detecting device can include a reference point located on the detecting device, for positioning of the detecting device. This reference point could be visible on the device itself. For example, an arrow could be provided which the user has to point to a television, thereby positioning the detecting device. In this case, the position and shape of the location grid in relation to the signal detected remains the same. The north location would be shown on the side of the reference point.

The detecting device could also be configured to detect a reference signal and position a logical location map (such as the location grid 28) according to the detected reference signal. This could be found by detecting the presence of a reference signal in the detected signal. For example, by first locating the television (by locating the content of the television in the detected signal) the location grid 28 could be shaped and rotated in such a way that the north location would be mapped onto the television location.

The following extension can also be proposed to the basic embodiment:

Instead of analysing one image of the camera in a dark environment it is also possible to analyse two images of the camera in a non-dark environment. In this way, one image is taken before the illumination of the lighting device 16 and one after. The part of the location grid with the highest difference in light intensity of the images provides the location of the effect generated by the lighting device 16.

Instead of analysing an image, video of the scene can be analysed after sending an operation signal as an amBX light command to an amBX lighting device 16. In this way, also the delay can be determined between sending an amBX light commands to the lighting device 16 and the moment of illumination of the lighting device 16 (taking the delay of the video camera in mind). This means that the communication delay between the amBX system and a specific lighting device can be determined by using the control system 12.

By analysing a coloured signal, such as a coloured image or video, the colour difference of an amBX lighting device 16 and the video content on a TV screen to which the colour of the lighting device 16 should match can be determined by the control system 12. In this case the lighting device and TV screen could both be visible in the field of view of the sensor 14. The control system 12 can store the colour correction at the amBX engine 20, which can take this correction into account when sending amBX light commands to the amBX lighting device 16.

By analysing the intensity of a lighting device based on different outputs (e.g. 100% intensity, 50% intensity, 25% intensity) the intensity curve can be calculated. The result of the calculation can be used to determine if this curve is logarithmic or linear. It can also be used to determine what the fading curve of the lighting device 16 looks like. By using a camera as the sensor 14, the effect of the lighting device 16 in its surrounding environment can be measured.

Other types of devices can also be located in a similar way. By using a directional sensor for wind detection, the location and height of a fan/blower can be detected. For sound devices, some directional measurements on the received sound volume can be used to decide on the location (this could also be used for Home Theatre devices with 5.1 or 6.1 stereo).

1. A method comprising:
transmitting an operate signal from a control system to an effects device,
operating the effects device according to the operate signal,
detecting an effect of the effects device, and
assigning a location to said effect, and storing the location of said effect.

2. A method according to claim 1, further comprising:
storing identification data identifying said effects device.

3. (canceled)

4. A method according to claim 1 further comprising:
repeating the method for multiple effects devices.

5-7. (canceled)

8. A method according to claim 1, wherein storing the location of said effect comprises storing the location on a storage device in the respective effects device.

9. A method according to claim 1, wherein storing the location of said effect comprises storing the location on a storage device in the control system.

10. A method according claim 1, further comprising:
measuring a delay between transmitting the operate signal from the control system to the effects device, and
detecting the effect of the effects device.

11. A method according to claim 1, further comprising:
transmitting a series of different operate signals from the control system to the effects device,
operating the effects device according to the different operate signals, and
calculating an intensity curve for the effects device.

12. A method according to claim 1, further comprising:
detecting an effect of a test device and measuring a difference between the effect of the effects device and the effect of the test device.

13. A method according to claim 1, further comprising:
simultaneously transmitting an operate signal from the control system to a second effects device,
operating the second effects device according to the operate signal,
detecting a combined effect of the two effects devices, and
assigning a location to said combined effect, and
storing the location of said combined effect.

14. A method according to claim 1, further comprising:
positioning a detecting device, the detecting device for detecting an effect of the effects device, said positioning according to a reference point located on said detecting device.

15. A method according to claim 1, and further comprising:
detecting a reference signal and positioning a logical location map according to the detected reference signal.

16. A system comprising:
a control system,
a detecting device and
at least one or more effects devices,
the control system arranged to transmit an operate signal to an effects device,
the effects device arranged to operate according to the operate signal,
the detecting device arranged to detect an effect of the effects device, and
the control system further arranged to assign a location to said effect and to store the location of said effect.

17. (canceled)

18. A system according to claim 16, wherein the effects device comprises one of a lighting device, an audio device, a display device, a fan and a smoke device.

19-24. (canceled)

25. A system according to claim 16, wherein the control system is further arranged to measure a delay between transmitting the operate signal to the effects device, and the detecting of the effect of the effects device.

26. A system according to claim 16, wherein the control system is further arranged to transmit a series of different operate signals to the effects device, the effects device arranged to operate according to the different operate signals, and the control system arranged to calculate an intensity curve for the effects device.

27. A system according to claim 16, wherein the detecting device is further arranged to detect an effect of a test device and to measure a difference between the effect of the effects device and the effect of the test device.

28. A system according to claim 16, wherein the control system is further arranged simultaneously to transmit an operate signal to a second effects device, the second effects device arranged to operate according to the operate signal, the detecting device arranged to detect a combined effect of the two effects devices, the control system arranged to assign a location to said combined effect, and to store the location of said combined effect.

29. A system according to claim 16, wherein the detecting device comprises a reference point located on said detecting device, for positioning of the detecting device.

30. A system according to claim 16, wherein the detecting device is arranged to detect a reference signal and the control system is arranged to position a logical location map according to the detected reference signal.

31. A computer program product for operating a system comprising a computer readable medium having embodied thereon computer program code comprising:
computer program code for transmitting an operate signal from a control system to an effects device,
computer program code for operating the effects device according to the operate signal,
computer program code for detecting an effect of the effects device,
computer program code for assigning a location to said effect, and
computer program code for storing the location of said effect.

32-42. (canceled)
